(19) United States
(12) Patent Application Publication
(10) Pub. No.: US 2022/0286082 A1
(43) Pub. Date: Sep. 8, 2022

(54) ADJUSTABLE SOLAR PANEL SYSTEM

(71) Applicants: John Hollstedt, Knutsford (CA); Greg Lambertus, Kamloops (CA); Christopher Irving, Kamloops (CA)

(72) Inventors: John Hollstedt, Knutsford (CA); Greg Lambertus, Kamloops (CA); Christopher Irving, Kamloops (CA)

(21) Appl. No.: 17/689,758

(22) Filed: Mar. 8, 2022

Related U.S. Application Data
(60) Provisional application No. 63/158,340, filed on Mar. 8, 2021.

(51) Int. Cl. H02S 20/30; H02S 30/10

(52) U.S. Cl. CPC H02S 20/30; H02S 30/10

(57) ABSTRACT

Disclosed is an apparatus for supporting a plurality of solar panels comprising an upright extending from and supported by a surface to a top distal end, a frame pivotally supported at the top distal end of the upright, the frame operable to support a plurality of solar panels thereon and an adjustable brace extending from the frame to the upright being adapted to adjust the angle of the frame relative to the upright.

### CROSS REFERENCE TO RELATED APPLICATION

This application claims benefit of U.S. Provisional Patent Application Ser. No. 63/158,340 filed Mar. 8, 2021 entitled Solar Panel Adjusting Bracket.

### BACKGROUND

### 1. Technical Field

This disclosure relates generally to solar panels and in particular to a method and system for adjusting the angle of incidence of a solar panel to account for seasonal variations in the angle of the sun

### 2. Description of Related Art

Photovoltaic, or solar panels are commonly utilized to collect the sun's rays and produce electricity from such collection. It is known, however that the amount of electricity produced by such solar panels is related to the angle at which the sun's rays encounter the surface of the solar panel. Therefore, it will therefore be appreciated that in order to improve the efficiency it will be desirable to orient the angle of the solar panels to be perpendicular to the sun's rays.

One difficulty in properly positioning and angling solar panels is that the sun's angle or height in the sky continuously changes throughout the year. Thus, the selected angle of inclination of the solar panels is often a compromise selected to either maximize the overall energy collected through the year or at a particular time or season.

Previous attempts to adjust the angle of inclination of the solar panels have not been practical or cost effective. In particular, some attempts have been made to provide solar trackers that utilize actuators to vary the angle of the solar panel to track the sun's movement. However, such systems are complicated to configure, expensive and add additional complexity to such installations.

Similarly, many solar panels may include one or more brace extending from the solar panel supporting frame to a base structure, such as a post. It is therefore been proposed to move the position on the post where the support brace extends to in order to adjust the angle of the solar panels. However, disadvantageously, such methods, typically involve loosening the connection between the support brace and the solar panel frame and moving such connection to a new location. It will be appreciated that such operation is time consuming and prone to reconnection at an incorrect position.

### SUMMARY OF THE DISCLOSURE

According to a first embodiment, there is disclosed an apparatus for supporting a plurality of solar panels comprising an upright extending from and supported by a surface to a top distal end, a frame pivotally supported at the top distal end of the upright, the frame operable to support a plurality of solar panels thereon and an adjustable brace extending from the frame to the upright being adapted to adjust the angle of the frame relative to the upright.

The adjustable brace may have an adjustable length. The adjustable brace may include first and second telescoping members wherein the first telescoping member is connected to the frame and the second telescoping member is connected to the upright. The first and second telescoping members may be securable to each other at a plurality of positions to define a plurality of lengths of the adjustable brace. The one of the first and second telescoping members may include a plurality of sets of bores extending transversely therethrough adapted to receive a pin extending through the other of the first and second telescoping members. The plurality of bores may be spaced along the first or second telescoping member so as to provide a plurality of lengths for the adjustable brace operable to orient the frame at angles of inclination corresponding to different angles of inclination of the sun in different seasons.

The first telescoping member may be rotatably connected to the frame. The second telescoping member may be rotatably connected to the upright.

The upright may comprise a pole. The apparatus may further comprise a brace receiving bracket. The brace receiving bracket may be clamped to the pole.

The upright may include a plurality of receivers thereon adapted to connect to the adjustable brace at one of a plurality of positions. The plurality of receivers may be spaced along the upright at positions corresponding to different angles of inclination of the sun in different seasons. The adjustable brace may be connected to one of the plurality of receivers with a selectably removable pin.

The upright may include a hinge pin extending transversely thereacross at the top distal end of the upright. The hinge pin may comprise a rigid tubular member. The frame may include at least one bore therethrough sized to rotatably receive the hinge pin therein. The apparatus may further comprise collars located on the hinge pin adapted to retain the bores at a desired location along the hinge pin. The apparatus may further comprise at least one solar panel secured to a top surface of frame.

According to a further embodiment, there is disclosed a method for supporting a plurality of solar panels comprising providing an upright extending from and supported by a surface to a top distal end at a desired location, pivotally supporting a frame pivotally at the top distal end of the upright, the frame operable to support a plurality of solar panels thereon and an adjustable brace extending from the frame to the upright being adapted to adjust the angle of the frame relative to the upright.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of a solar panel support system according to a first embodiment of the present disclosure.

FIG. 2 is a side view of the solar panel support system of FIG. 1 at a first configuration.

FIG. 3 is a side view of the solar panel support system of FIG. 1 at a second configuration.

FIG. 4 is a detailed exploded view of the adjustable brace of the solar support system of FIG. 1.

FIG. 5 is a detailed perspective view of the hinge of the solar panel support system of FIG. 1.

FIG. 6 is an exploded view of the frame and solar panel assembly of the solar panel support system of FIG. 1.

FIG. 7 is a side view of a solar panel support system according to a further embodiment at a first configuration.

FIG. 8 is a side view of the solar panel support system of FIG. 7 at a second configuration.

### DETAILED DESCRIPTION

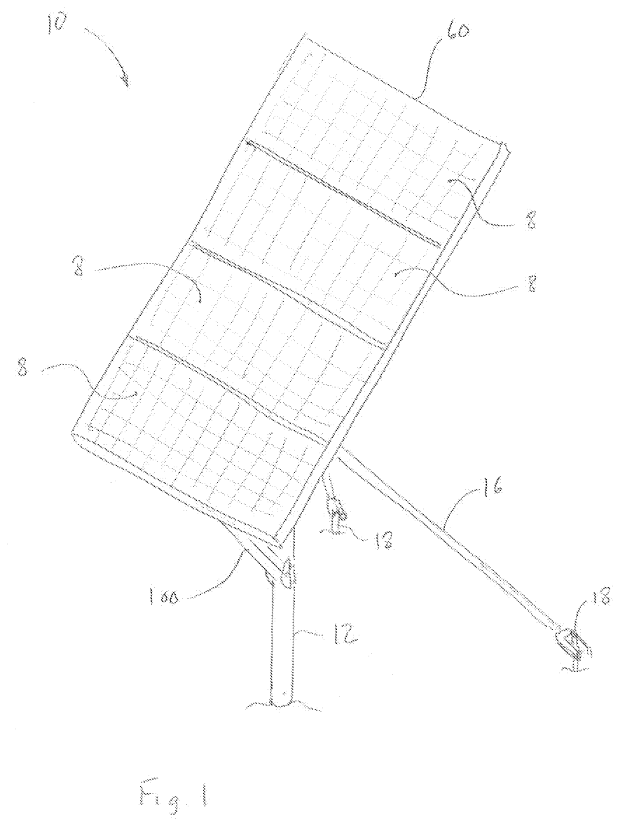

Aspects of the present disclosure are now described with reference to exemplary apparatuses, methods and systems. Referring to FIG. 1, an exemplary apparatus for supporting a plurality of solar panels 8 according to a first embodiment is shown generally at 10. The apparatus 10 comprises an upright 12 supporting a pivotally connected solar panel frame 60 at a top end thereof. An adjustable brace 100 extends between the frame and the upright to permit the angle of inclination, generally indicated at 11, of the frame and solar panels 8 to be adjusted to one of a plurality of angles corresponding to the angle of incidence of the sun 4.

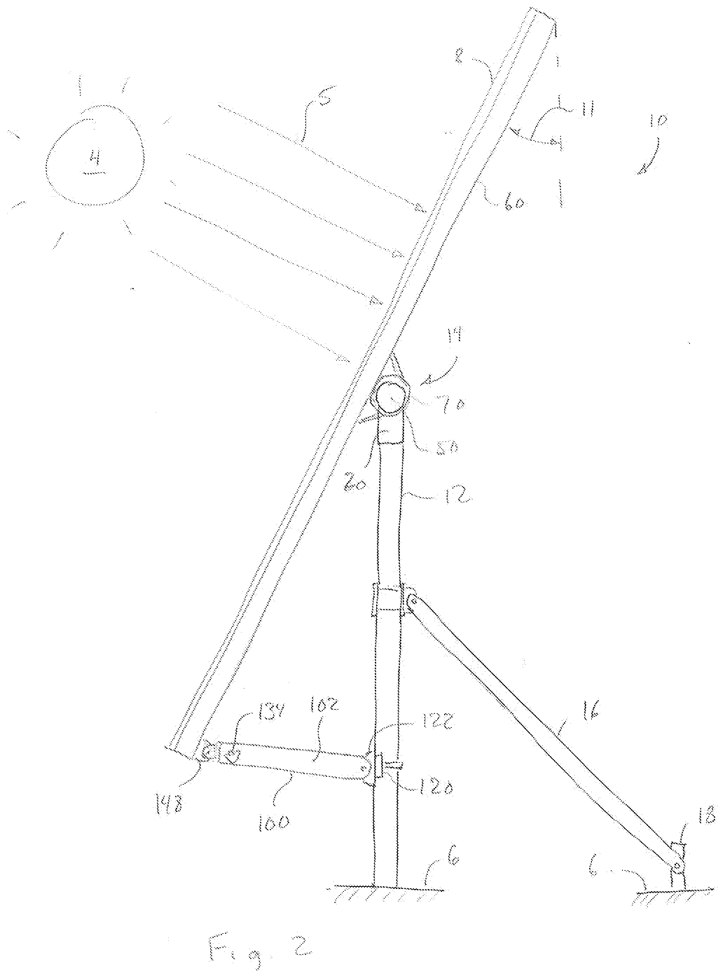

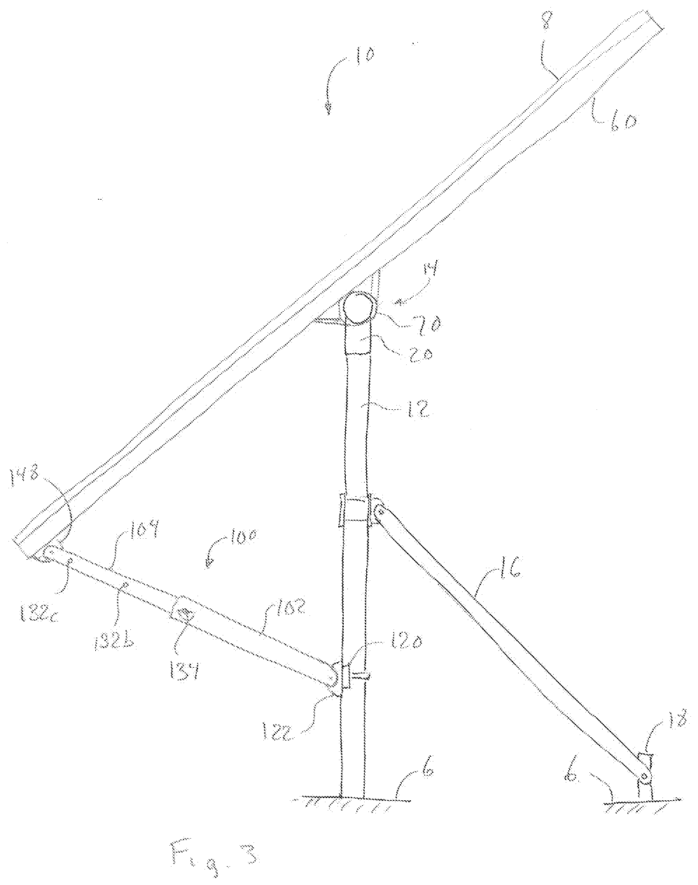

Turning now to FIGS. 2 and 3, the upright extends from a ground surface 6 to a top distal end 14. It will be appreciated that the upright may be embedded within the ground or may optionally be secured to a building or other structure including frames or skids for locating at a desired location. As illustrated, the upright 12 may comprise a pole although other shapes may be utilized as well. As illustrated in FIGS. 2 and 3, the upright may include one or more braces 16 extending therefrom to the ground surface for reinforcing the upright. As illustrated, the braces 16 may extend diagonally to a ground anchor 18 as illustrated and may optionally include more than one brace extending to horizontally spaced apart locations as illustrated in FIG. 1.

Optionally, the same ground anchor may be utilized for supporting adjacent uprights 12.

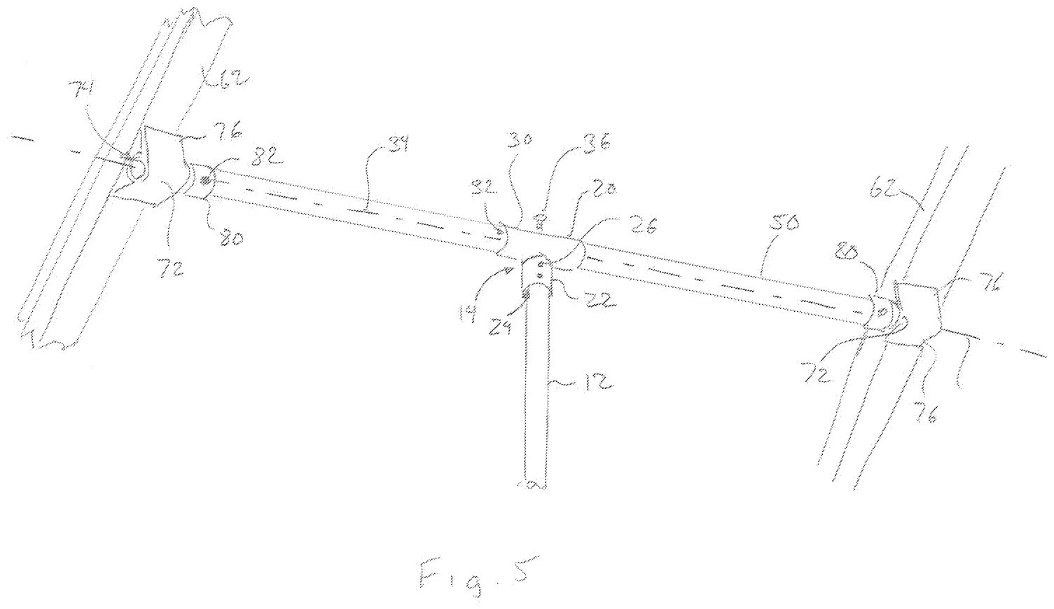

As illustrated in FIG. 5, the upright may include a t-shaped member 20 at a top end thereof. In particular, the t-shaped member may include a vertical portion 22 having a bore 24 adapted to receive the upright 12 therein. One or more fasteners 26, such as set screws or the like may secure the vertical portion 22 around the upright although it will be appreciated that other connecting means, including, without limitation, welding, adhesives or the like may also be utilized to secure the vertical portion 22 to the upright 12. The t-shaped member 20 also includes a horizontal portion 30 having a horizontal bore 32 extending therethrough. The horizontal bore 32 defines an axis of rotation 34 for the frame as will be more fully set out below and is sized to pass a hinge pin 40 therethrough as will be more fully set out below. In operation, the axis 34 will be oriented substantially horizontally and aligned so as to be perpendicular to the expected position of the sun. By way of non-limiting example, in many locations around the world the axis 34 will be oriented in an east-west direction so as to allow the solar panels to capture energy from the sun for the longest period of the day.

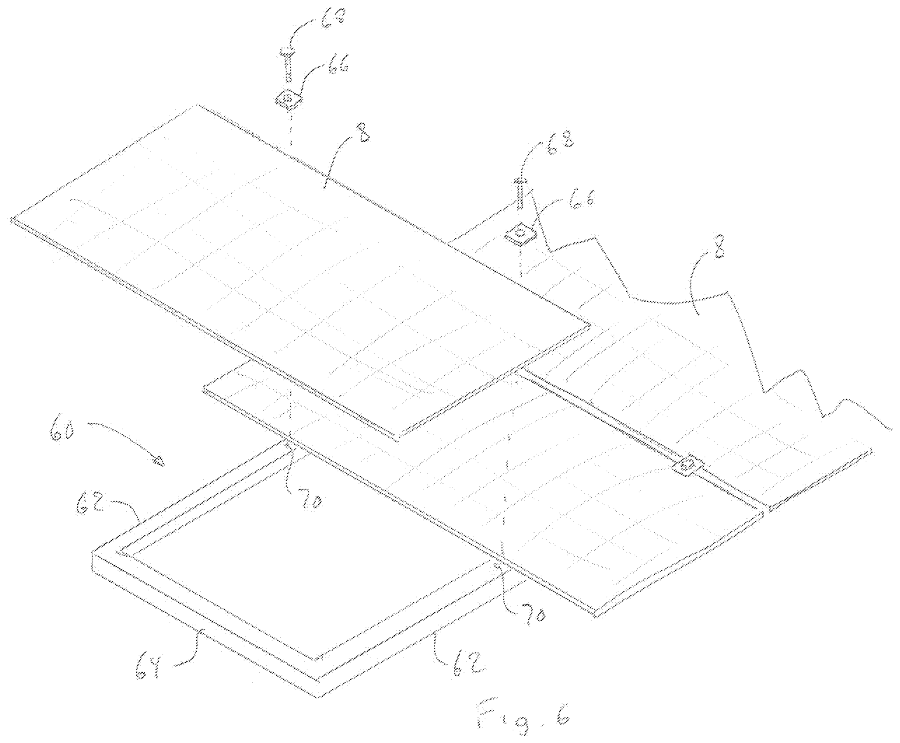

Turning now to FIG. 6, the frame 60 comprises at least two longitudinal members 62 and a plurality of cross members 64 extending therebetween. The frame 60 supports the solar panels 8 thereon with a plurality of clamp members 66 located thereover and secured to the frame with fasteners 68 passed between the solar panels 8 and secured within bores 70 in the frame. As illustrated, the solar panels 8 may comprise 4 solar panels arranged to extend horizontally across the frame 60 although it will be appreciated that other solar panel configurations may be utilized as well. As illustrated in FIG. 5, the longitudinal members 62 may support at least one tubular member 72 having a bore 74 extending thereacross. The bores 74 are selected to have a bore corresponding to the diameter of the hinge pin 50 as set out below so as to be freely rotatably therearound. The frame 60 may be of any suitable support structure, such as, by way of non-limiting example, formed of steel, aluminium or other materials and be designed to support the solar panels in a substantially planar arrangement thereon.

A hinge pin 50 is sized to be received within the horizontal bore 32 as illustrated in FIG. 5. Thereafter, a set screw 36 or other suitable fastening means may be utilized to secure the hinge pin 50 along the axis 34. The hinge pin 50 may include a pair of collars 80 sized to surround the hinge pin and including a set screw 82 or the like. The collars 80 are positioned proximate to an inside of the tubular members 72 so as to prevent longitudinal movement of the tubular members and therefor also the frame on the hinge pin 50.

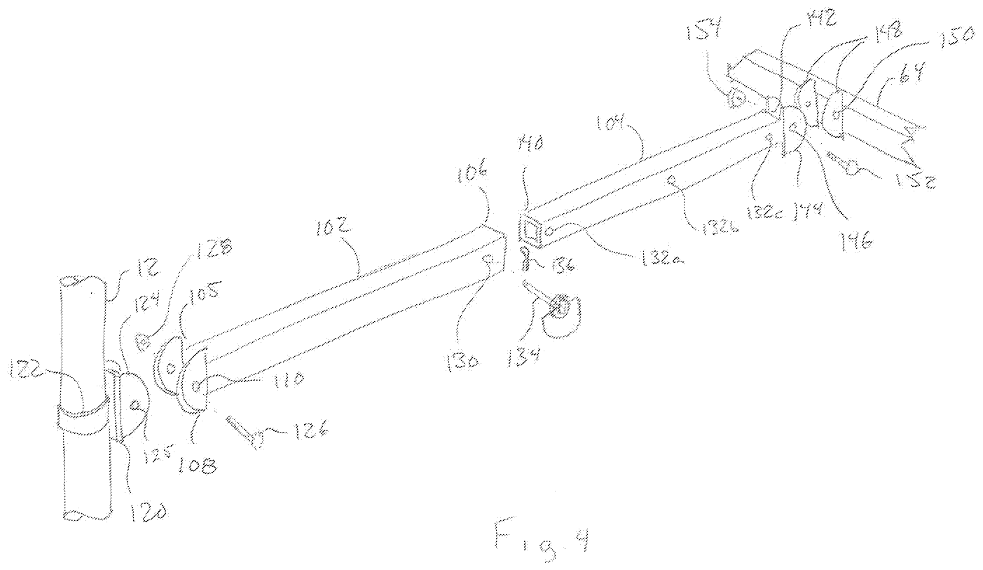

Turning now to FIG. 4, the adjustable brace 100 extends between the upright and a member of the frame, such as, by way of non-limiting example, a cross member 64. The adjustable brace 100 has an adjustable length so as to permit the angle of the solar panels to be adjusted about the hinge pin 50. In particular, as illustrated in FIG. 4, the adjustable brace 100 may comprise an outer and an inner member 102 and 104, respectively, wherein the inner member 104 is telescopingly received within the outer member 102. The outer member extends between first and second ends, 105 and 106, respectively wherein the second end includes an opening to receive the inner member therein. The first end includes at least one plate 108 extending substantially vertically with a bore 110 therethrough. The upright 12 includes a receiving bracket 120 secured thereto with a clamp 122 or the like and also includes at least one vertical plate 124 with a bore 125 extending horizontally therethrough. In operation, the bores 125 and 110 may be aligned and a fastener 126 or pin passed therethrough to rotatably connect the outer member 102 to the upright. A nut 128 or other securing means may secure the fastener 126 through the bores 110 and 125. The second end 106 of the outer member includes a bore 130 proximate thereto.

The inner member extends between first and second ends, 140 and 142, respectively and is sized to be received within the outer member 102. The second end 142 includes at least one plate 144 extending substantially vertically with a bore 146 therethrough. The frame 60 includes a receiving also includes at least one vertical plate 148 with a bore 150 extending horizontally therethrough. In operation, the bores 150 and 146 may be aligned and a fastener 152 or pin passed therethrough to rotatably connect the inner member 104 to the frame. A nut 154 or other securing means may secure the fastener 152 through the bores 146 and 150. The outer member 104 includes a plurality of bores 132a, 132c and 132c extending therethrough. The bores 132a-132c are positioned to be aligned with the bore 130 when the inner member 104 is located within the outer member 102 at a desired length. Thereafter a pin 134 may be passed therethrough so as to fix the length of the adjustable bracket. Optionally, a cotter pin or the like may be utilized to retain the pin 134 within the bores as is commonly known. The bores 132a-132c are positioned to correspond to a required length of the adjustable bracket so as to position the solar panels at an angle corresponding to normal to the sun at one of a plurality of times through the year, eg. summer or autumn. In particular the bore 132c closest to the second end 142 will result in the shortest adjustable bracket and therefore the most upright solar panels which may be particularly useful for winter as illustrated in FIG. 2. Correspondingly, the bores 132a closest to the first end 140 will result in the longest adjustable bracket and therefore the most reclined solar panels which may be particularly useful for summer as illustrated in FIG. 3. It will be appreciated that although three bores 132a, 132b and 132c are illustrated, that more or less may also be utilized depending on the number of positions desired.

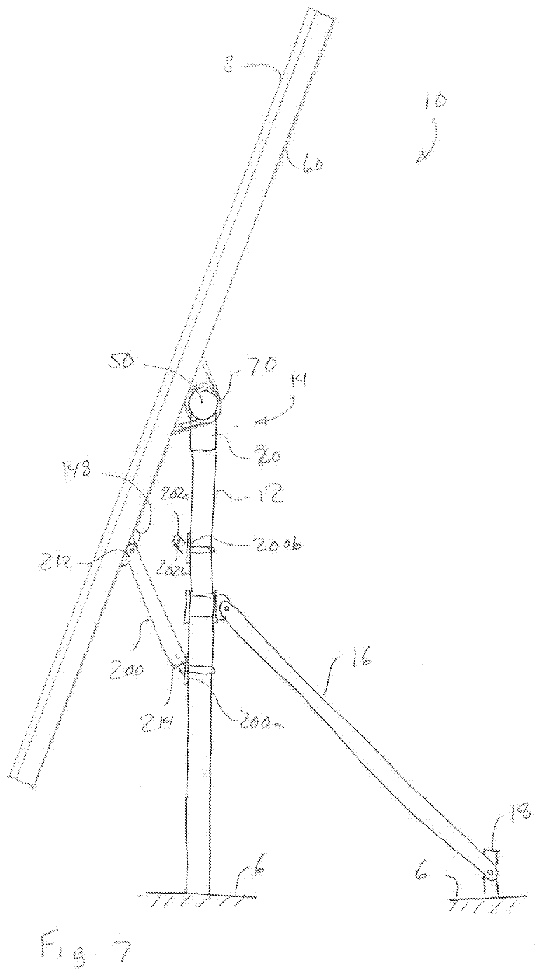

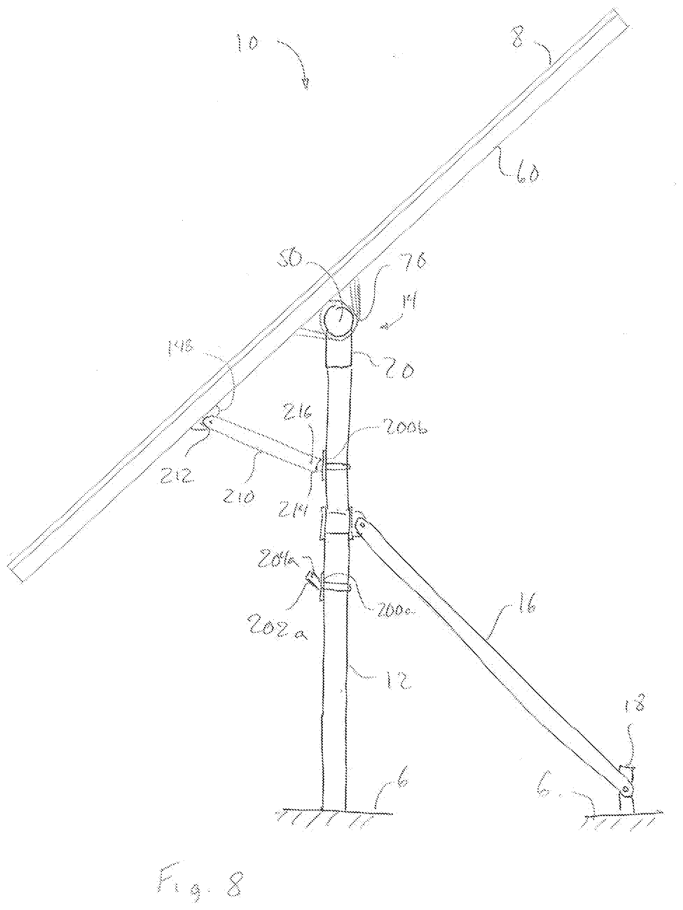

Optionally, as illustrated in FIGS. 7 and 8, the adjustable brace 210 may have a fixed length and be connectable to one of a plurality of locations along the upright 12. In particular, the upright 12 may include a plurality of receiving brackets 200a and 200b, adapted to support and angle the frame 60 according to a desired angle of inclination at a selected season. As illustrated each bracket 200a or 200b may comprise a body secured to the upright 12 having a connector 202a or 202b, such as, by way of non-limiting example, a projection. Each of the bodies may be adjustably located on the upright at the time of installation and thereafter remain at that location when shifting the solar panels between seasonal settings.

The adjustable brace 210 extend between first and second ends, 212 and 214, respectively and is pivotally connected to the panel support frame 60 as set out above at the first end. The second end 214 may include an opening adapted to receive the projection 202a or 202b therein. The adjustable brace 210 may further includes a bore 216 to pass a pin, fastener, or other body through corresponding to a corresponding bore 204a or 204b in the projections. When the adjustable brace is secured to the topmost bracket 202b, the solar panels 8 will be most reclined position which may be particularly useful for summer as illustrated in FIG. 8. When the adjustable brace is secured to the bottom most bracket 202a, the solar panels 8 will be at their most upright position which may be particularly useful for winter as illustrated in FIG. 7.

While specific embodiments have been described and illustrated, such embodiments should be considered illustrative only and not as limiting the disclosure as construed in accordance with the accompanying claims.

What is claimed is:

1. An apparatus for supporting a plurality of solar panels comprising:
an upright extending from and supported by a surface to a top distal end;
a frame pivotally supported at the top distal end of the upright, the frame operable to support a plurality of solar panels thereon; and
an adjustable brace extending from the frame to the upright being adapted to adjust the angle of the frame relative to the upright.

2. The apparatus of claim 1 wherein the adjustable brace has an adjustable length.

3. The apparatus of claim 2 wherein the adjustable brace includes first and second telescoping members wherein the first telescoping member is connected to the frame and the second telescoping member is connected to the upright.

4. The apparatus of claim 3 wherein the first and second telescoping members are securable to each other at a plurality of positions to define a plurality of lengths of the adjustable brace.

5. The apparatus of claim 4 wherein the one of the first and second telescoping members includes a plurality of sets of bores extending transversely therethrough adapted to receive a pin extending through the other of the first and second telescoping members.

6. The apparatus of claim 5 wherein the plurality of bores are spaced along the first or second telescoping member so as to provide a plurality of lengths for the adjustable brace operable to orient the frame at angles of inclination corresponding to different angles of inclination of the sun in different seasons.

7. The apparatus of claim 3 wherein the first telescoping member is rotatably connected to the frame.

8. The apparatus of claim 1 wherein the second telescoping member is rotatably connected to the upright.

9. The apparatus of claim 1 wherein the upright comprises a pole.

10. The apparatus of claim 9 further comprising a brace receiving bracket.

11. The apparatus of claim 10 wherein the brace receiving bracket is clamped to the pole.

12. The apparatus of claim 1 wherein the upright includes a plurality of receivers thereon adapted to connect to the adjustable brace at one of a plurality of positions.

13. The apparatus of claim 12 wherein the plurality of receivers are spaced along the upright at positions corresponding to different angles of inclination of the sun in different seasons.

14. The apparatus of claim 13 wherein the adjustable brace is connected to one of the plurality of receivers with a selectably removable pin.

15. The apparatus of claim 1 wherein the upright includes a hinge pin extending transversely thereacross at the top distal end of the upright.

16. The apparatus of claim 15 wherein the hinge pin comprises a rigid tubular member.

17. The apparatus of claim 16 wherein the frame includes at least one bore therethrough sized to rotatably receive the hinge pin therein.

18. The apparatus of claim 17 further comprising collars located on the hinge pin adapted to retain the bores at a desired location along the hinge pin.

19. The apparatus of claim 1 further comprising at least one solar panel secured to a top surface of frame.

20. A method for supporting a plurality of solar panels comprising:
providing an upright extending from and supported by a surface to a top distal end at a desired location;
pivotally supporting a frame pivotally at the top distal end of the upright, the frame operable to support a plurality of solar panels thereon; and
an adjustable brace extending from the frame to the upright being adapted to adjust the angle of the frame relative to the upright.
